(19) United States
(12) Patent Application Publication
(10) Pub. No.: US 2003/0058960 A1
(43) Pub. Date: Mar. 27, 2003

(54) Predistortion type-linearized power amplification system using digital if technology

(75) Inventor: Jae-Hyuk Lee, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/244,391

(22) Filed: Sep. 17, 2002

(30) Foreign Application Priority Data
Sep. 21, 2001 (KR) 58751/2001

(51) Int. Cl. H04K 1/02

(52) U.S. Cl. 375/297

(57) ABSTRACT

A power amplification system uses digital intermediate frequency (IF) processing to increase the linearity of a high-pass amplifier which may be used, for example, in a variety of communications applications. The system includes a preprocessing unit which digitally processes I- and Q-phase digital input signals, a digital-to-analog converter which converts the preprocessed signals into an analog signal, and a mixer for up-converting the analog signal based on an intermediate frequency. The resulting signal is amplified by the amplifier. The preprocessing unit includes a predistortion unit having a characteristic which is inverse to the nonlinear distortion characteristic of the amplifier. The inverse characteristic is defined based on information output from another digital processor located in a feedback loop connecting the digital IF processor to the predistortion unit. By performing digital IF processing before analog conversion, the system improves the linearization of the amplifier by removing imbalances and other adverse affects that occur in conventional amplifier control circuits.

### BACKGROUND OF THE INVENTION

1. Field of the Invention

The present invention relates to a high-power amplifier (HPA) of a transmitter, and more particularly to a predistortion type-linearized power amplification system using IF technology.

2. Background of the Related Art

A high-power amplifier (HPA) is a power amplifier which is usually installed at an utmost end of a transmitter for amplifying and broadcasting high-frequency signals, and it is a part which mainly contributes to the non-linearization of the transmitting system.

Methods for improving the non-linearized characteristic of power amplifier include the Feed Forward method, the Envelope Feedback method, and the Predistortion method. The predistortion method linearizes the output of a power amplifier by predistorting an input signal inversely with the non-linearized characteristic of the power amplifier. In practice, the predistortion method has proven to have high-cost performance. However, because it operates in a wide bandwidth it is commonly used.

FIG. 1 is a block diagram showing a conventional digital linearizer. This digital linearizer includes a predistorter 10 for distorting digital input signals by adjusting the level of the digital input signals so that a characteristic is inverse to the nonlinearized distortion characteristic of the HPA, an up-converter 20 for converting the output signal of the predistorter 10 to a high-frequency signal, and a HPA 30 for amplifying the high-frequency signal output from the up-converter 20. The digital linearization also includes a digital-signal processor 50 (DSP) for controlling predistortion of the predistorter 10 using a baseband feedback signal and the digital input signal, a directional coupler 32 for extracting the output of the HPA 30 in a predetermined rate, a feedback unit 40 for feeding the baseband signal to the DSP 50 by converting the signal from the directional coupler back to lower frequency, and a local oscillator 25 for supplying local oscillation frequencies for modulating and demodulating to the up-converter 20 and feedback unit 40. A terminator 34 is also for terminating the end of the transmission line so that it does not reflect the output signal of the HPA 30, which passes through the directional coupler 32.

Operation of this circuit will now be described. When a signal is input into the predistortion-type digital linearizer through the I and Q channels, predistorter 10 determines the amount to be distorted by measuring the size of the input signal, e.g., its power. After appropriately adjusting the input signal, predistorter 10 sends distorted I/Q signals to respective D/A converters 21A and 21B in up-converter 20. The D/A converters input the distorted I/Q signals into the quadrature modulator 22 after converting them into analog signals. The quadrature modulator combines (mixes) the analog I/Q signal to form a higher-frequency signal, and this signal is then input into to the HPA 30. The HPA 30 amplifies the high-frequency signal and broadcasts it through an antenna. The directional coupler 32 extracts the signal output from the HPA and sends the extracted signal to quadrature modulator 41 of feedback unit 40. The quadrature modulator down-converts the signal from the directional coupler 32 into respective baseband signals and sends the baseband signals to A/D converters 42A and 42B. The DSP 50 generates a gain-control signal Gctl and sends the gain-control signal Gctl to the predistorter, so that the predistorter may control predistortion based on the gain-control signal Gctl.

In the above-described predistortion-type digital linearizer, since an analog modulator or demodulator is used to convert the frequency to a higher or lower frequency, there is a limitation in linearization of the final output signal of the digital linearizer, because the input signal of the HPA can be distorted due to an imbalance of the digital input signals I and Q and a tolerance of an analog circuit.

### SUMMARY OF THE INVENTION

It is an object of the present invention to provide a linearized power amplification system which demonstrates improved linearization characteristics compared with conventional systems of this type.

It is another object of the present invention to achieve the aforementioned object by compensating for distortion factors caused by analog modulation/demodulation as well as the HPA using digital IF technology.

To achieve the object of the present invention, a predistortion type-linearized power amplification system of the present invention comprises a predistorter for distorting the I and Q phases digital input signals so as to have a characteristic which is inverse to the nonlinearized characteristic of the output signal of the HPA, using the coefficient from the DSP; a digital IF processing unit for modulating the I′ and Q′ signals pre-distorted by the predistorter and sending the modulated signals to the D/A converter, and demodulating the signal from the feedback circuit and inputting the demodulated signal to the DSP; a D/A converter for converting I′ and Q′ signals outputted from the preprocessing unit into analog signals; an up-mixer for up-converting the analog signals by multiplying the analog signal with the local oscillation frequency; a high power amplifier (HPA) for amplifying and transmitting a high frequency signal outputted from the up-mixer into the air; a feedback circuit for extracting output signal from the HPA and converting the output signal into a digital signal so as to provide the digital signal to the preprocessing unit; and a digital signal processor (DSP) for generating a coefficient for controlling the preprocessing unit using the I and Q phases digital input signals and the output signal of the HPA, which is processed in the digital domain by the preprocessing unit.

The predistorter includes a gain control module for adjusting level of the digital input signals according to a gain control signal from the DSP and a predistortion module for distorting the digital input signal adjusted in the gain control module so as to have a characteristic which is inverse to the nonlinear distortion characteristic of the HPA.

The predistortion module includes a power measurement unit for measuring power level of the signal from the gain control module, a predistortion work function generation unit for generating a predistortion work function based on the power level of the signal and a coefficient from the DSP, and a complex coupling unit for predistorting the input signal by performing complex coupling of the predistortion work function generated in the predistortion work function generation unit and the digital input signal.

The digital IF processing unit includes a modulation module for modulating the I′ and Q′ signals, and a demodulation module for demodulating the signal from the feedback circuit.

The modulation module includes a pair of first interpolators for increasing data rates of the I′ and Q′ signals by interpolating the respective I′ and Q′ signals, a pair of second interpolators for increasing the data rate of the signal interpolated in the first interpolator again, and a modulator for modulating the signal from the second interpolator.

The modulator includes a pair of multipliers for multiplying respectively 90°-advanced and 90°-delayed signals relative to the interpolated signal from the second interpolator and an adder for generating an IF signal by summing the signals outputted from the multipliers.

The demodulation module includes a demodulator for separating the feedback signal into two channels signal by demodulating the signal, a pair of decimators for decimating respective signals to ½ in date rage, and a pair of image filters for removing an image signal included in the decimated signals.

The demodulator includes a pair of multipliers for multiplying two separate channel signals with respective 90°-advanced (cos) and 90°-delayed (sin) signals.

The feedback circuit includes a directional coupler for extracting the output signal of the HPA, a down-mixer for down-converting the signal extracted in the directional coupler, an A/D converter for converting the signal from the down-mixer into a digital signal and sending the converted analog signal to the preprocessing unit, and a terminator for terminating the end of the transmission line so that the output signal of the HPA extracted by the directional coupler is not reflected.

### BRIEF DESCRIPTION OF THE DRAWINGS

The invention will be described in detail with reference to the following drawings in which like reference numerals refer to like elements wherein:

FIG. 1 is a block diagram showing a digital linearizer in accordance with the conventional predistortion method;

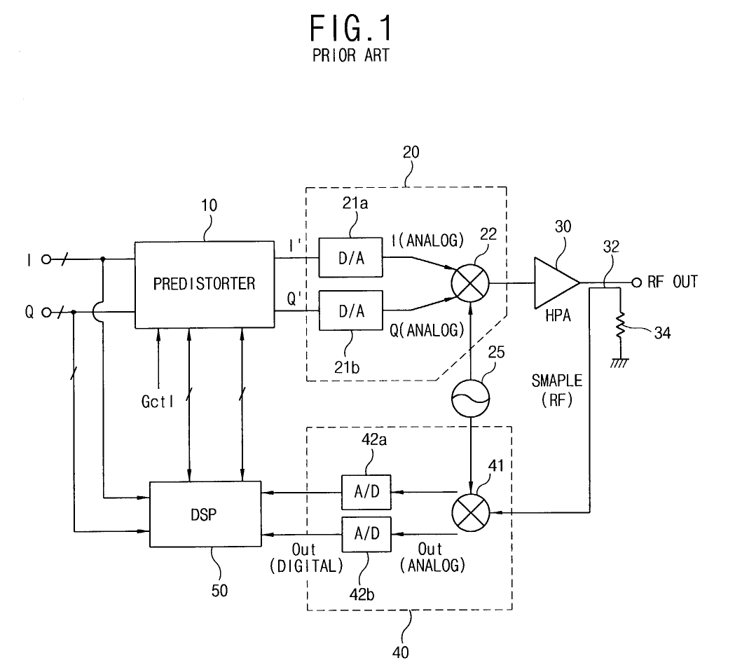

FIG. 2 is a block diagram showing a linearized power amplification system in accordance with a preferred embodiment of the present invention; and

FIG. 3 is a detailed circuit view showing a preprocessing unit of the linearized power amplification system of FIG. 2.

### DETAILED DESCRIPTION OF PREFERRED EMBODIMENTS

Reference will now be made in detail to the preferred embodiments of the present invention, examples of which are illustrated in the accompanying drawings.

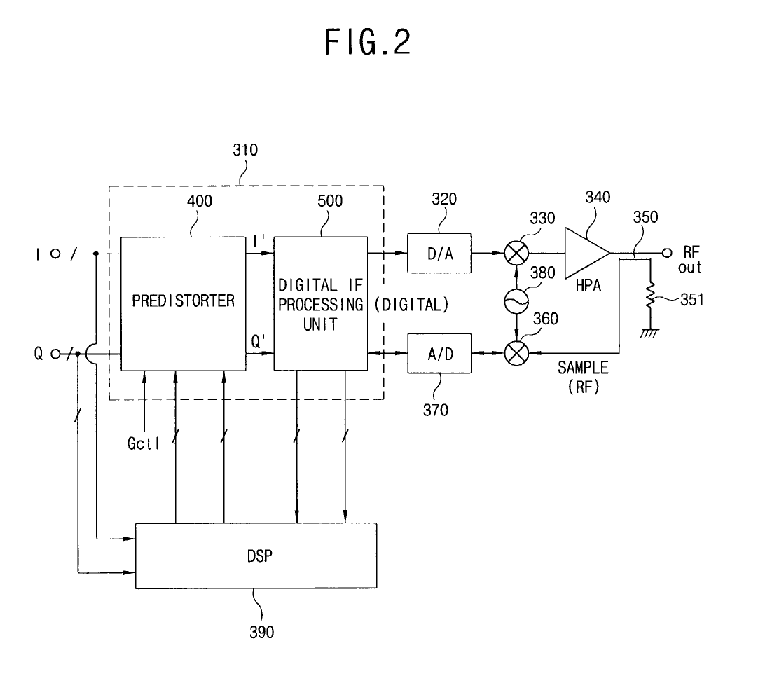

FIG. 2 is a block diagram showing a linearized power amplification system in accordance with a preferred embodiment of the present invention. This system includes a preprocessing unit 310 for processing I and Q phase digital input signals in a digital domain, a D/A converter 320 for converting I′ and Q′ signals output from the preprocessing unit 310 into analog signals, an up-mixer 330 for converting the analog signals by the local oscillation frequency, and a high power amplifier 340 for amplifying the up-converted signals and transmitting the amplified high frequency signal into the air. The system further includes a directional coupler 350 for extracting the output signal of the HPA 340, a down-mixer 360 for converting an output signal extracted by the directional coupler 350 into a lower frequency signal, an A/D converter 370 for converting the signal from the down mixer 360 into a digital signal and sending the digital signal to the preprocessing unit 310, and a local oscillator 380 for supplying local oscillation frequencies to the up-mixer 330 and down-mixer 360. Also included is a DSP 390 for generating a work function coefficient for controlling the preprocessing unit 310 using the I- and Q-phase digital signals and a baseband feedback signal from the preprocessing unit 310, and a terminator 351 for terminating the end of the transmission line so that the output signal extracted by the directional coupler 350 is not reflected. The terminator 351 is structured so as to have resistance of 50 ohm.

The preprocessing unit 310 includes a predistorter 400 and a digital IF processing unit 500. The predistorter distorts the I- and Q-phase digital input signals so as to have a characteristic which is inverse to the nonlinearized characteristic of the output signal of the HPA 340, after the levels of the I and Q signals are adjusted. The digital IF processing unit 500 performs QPSK modulation on the I′ and Q′ signals output from the predistorter 400 and the modulated signals are combined and input into the D/A converter 320, in a manner which separates them form the digital signals from the A/D converter 370. The resulting analog signal is output to the DSP 390 after image signals in the demodulated signals are removed.

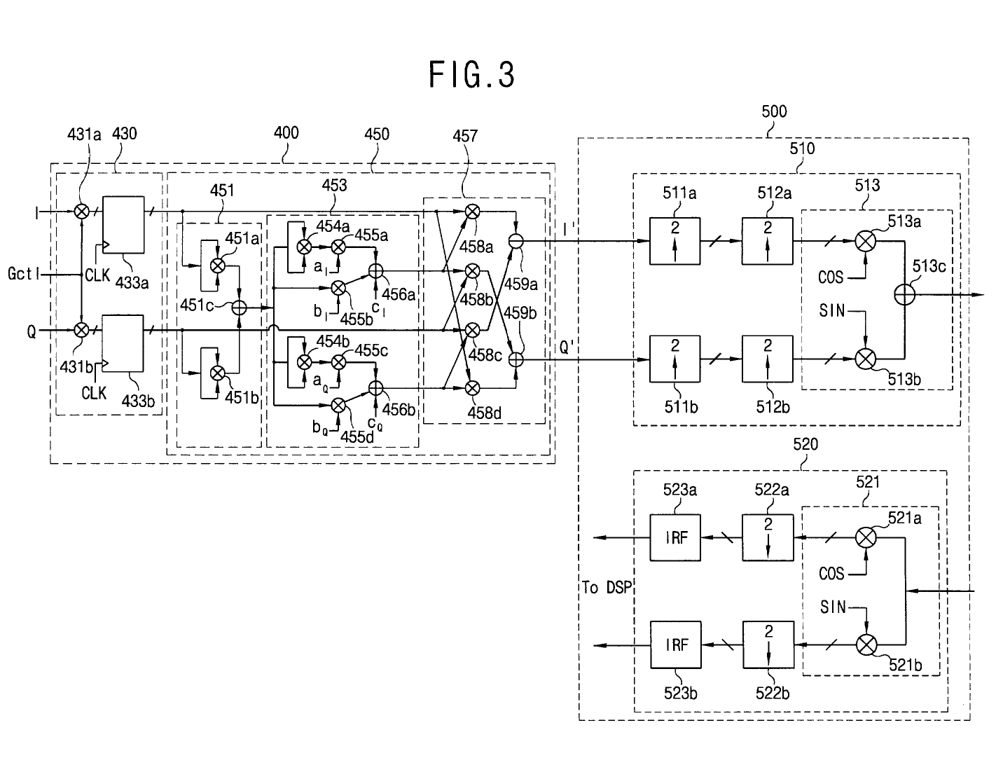

As shown in FIG. 3, the predistorter 400 includes a gain control module 430 for adjusting the level of the digital input signal according to a gain-control signal Gctl, and a predistortion module 450 for distorting the digital input signal which has been adjusted by the gain control module 430 such that the distorted signal has a characteristic which is inverse to the nonlinear distortion characteristic of the HPA 340.

The gain control module 430 includes a first multiplier 431a for adjusting the level of the I-phase digital input signal by multiplication with the gain control signal Gctl, a first flip flop 433a for setting input and output digits by taking a predetermined number of bits from the digital output signal of the first multiplier 431a, a second multiplier 431b for adjusting the level of the Q phase digital input signal by multiplication with the gain control signal Gctl, and a second flip flop 433b for setting a predetermined number of input and output digits by taking a predetermined bits from the digital output signal of the second multiplier 431b.

The predistortion module 450 includes a power measurement unit 451 for measuring a power level of the input signal, a predistortion work function generation unit 453 for generating a predistortion work function which determines a degree of distortion of the input signal according to the power level of the input signal, and a complex coupling unit 457 for predistorting the input signal by performing complex coupling of the predistortion work function and the digital input signal.

The power measurement unit 451 includes a first squarer 451a for squaring the I-phase digital input signal, a second squarer 451b for squaring the Q-phase digital input signal, and a first adder 451c for obtaining a level of the whole digital input signal by summing the outputs of the first and second squarers 451a and 451b.

The work function generation unit 453 includes a third multiplier 454a for squaring the output of the first adder 451c, a first coefficient multiplier 455a for multiplying the output signal of the third multiplier 454a with a quadratic term coefficient a₁ of the predistortion function for distorting the I-phase digital input signal, a second coefficient multiplier 455b for multiplying the output of the first adder 451c with a linear term coefficient b₁ of the predistortion function, a second adder 456a for outputting a predistortion work function corresponding to the I-phase digital input signal by summing the outputs of the first and second coefficient multiplier 455a and 455b and a constant term coefficient c₁ of the predistortion work function, a fourth squarer 454b for squaring the output of the first adder 451c, a third coefficient multiplier 455c for multiplying the output of the fourth squarer 454b with a quadratic term coefficient a_{Q} of the predistortion work function for distorting the Q-phase input signal, a fourth coefficient multiplier 455d for multiplying the output of the first adder 451c with a linear term coefficient b_{Q} of the predistortion work function for distorting Q-phase input signal, and a third adder 456b for outputting a predistortion work function corresponding to the Q-phase digital input signal by summing the outputs of third and fourth coefficient multipliers 455c and 455d and a constant term coefficient c_{Q} of the predistortion work function. The coefficients of the predistortion work functions corresponding to the I- and Q-phase digital input signals are updated by the digital DSP 390.

The complex coupling unit 457 includes a third multiplier 458a for multiplying the I-phase digital input signal with the output of the second adder 456a, a fourth multiplier 458b for multiplying the output of the second adder 456a with the Q-phase digital input signal, a fifth multiplier 458c for multiplying the Q-phase digital input signal with the output of the third adder 456b, a sixth multiplier 458d for multiplying the I-phase digital input signal with the output of the third adder 456b, an subtractor 459a for subtracting the output of the third multiplier 458a from the output of the fifth multiplier 458c so as to distort the I-phase digital input signal, and a fourth adder 459 for adding the output of the fourth multiplier 458b with the output of the sixth multiplier 458d so as to distort the Q-phase digital input signal.

The digital IF processing unit 500 includes a QPSK modulation module 510 for performing QPSK modulation of the I′ and Q′ signals outputted from the predistorter 400, and a QPSK demodulation module 520 for restoring the output signal from the A/D converter 370 by performing QPSK demodulation.

The QPSK modulation module 510 includes a pair of first interpolators 511a and 511b for interpolating the respective digital I′ and Q′ signals so as to be respectively doubled in the data rates, a pair of second interpolators 512a and 512b for interpolating the output signal from the first interpolators 511a and 511b so as to be respectively doubled in data rate, and a modulator 513 for modulating and then combining the signals output from the respective second interpolators 512a and 512b, so as to transfer the combined and modulated signal to D/A converter 320.

The modulator 513 includes a seventh multiplier 513a for multiplying the output signal from the second interpolator 512a with a 90° advanced signal (cos) relative to the output signal of the second interpolator 512a, an eighth multiplier 513b for multiplying the output signal from the second interpolator 512b by with 90° delayed signal relative to the output signal of the second interpolator 512b, and a fifth adder 513c for summing the output signals from the seventh and eighth multipliers 513a and 513b and performing the QPSK modulation on the summed signal so as to output an intermediate frequency signal.

The QPSK demodulation module 520 includes a demodulator 521 for demodulating the output signal of the A/D converter 370 into two channels, a pair of decimators 522a and 522b for decimating the data rates of the respective output signals from the demodulator 521 so as to be ½ in data rate, and a pair of image removing filters 523a and 523b for removing an image signal included in the output signal from the decimators so as to output a baseband signal to the DSP 390. The decimators 522a and 522b and the image removing filters 523a and 523b can be changed with each other in position.

The demodulator 521 includes a ninth multiplier 521a for demodulating one of the divided channel signals into the original I signal by multiplying the 90° advanced signal (cos) and a tenth multiplier 521B for demodulating the other channel signal into the original Q signal by multiplying the 90° delayed signal (sin).

The linearized power amplification system of the present invention may be structured so that the gain control signal Gctl is supplied either from an outside source or DSP 390. For convenience purposes, the gain control signal is shown as being supplied from DSP 390 in FIG. 2. The gain control signal is a signal which controls the level of the original digital input signal and is set according to the required output level of the HPA 340.

When the I- and Q-phase digital signals are input to the preprocessing unit 310, the gain control module 430 of the predistorter 400 multiplies the I- and Q-phase digital input signals with the gain control signal Gctl from the DSP 390. The number of bits of the gain controlled signal may be changed to preserve sine bits, and a few bits may be taken from the remaining lower bits so as to make the number of bits equal to that of synchronization signal.

After the levels of the I and Q signals are adjusted in the gain control module 430, they may be input into the predistortion module 450. The power measurement unit 451 of the predistortion module then measures the power level of the I and Q signals and the measured temperature value is input into the predistortion work function generation unit 453. The predistortion work function generation unit 453 then generates a new predistortion work function for the I and Q signals based on the temperature value from the temperature measurement unit 451. The coefficients of the respective terms of the predistortion work function are obtained from the DSP 390 and sends the new predistortion work function to the complex coupling unit 457. The complex coupling unit 457 distorts the I and Q signals by performing complex coupling of the I and Q signals and the predistortion work function so that the signals have a characteristic which is inverse to the nonlinear distortion characteristic of the HPA 340. Generally, in a linearization algorithm, the largest signal is regarded as 1, and accordingly, there is a limitation to increase of the level of the digital input signal since the highest bit of the fourteen-bit signal is regarded as 1.

In the embodiment of the present invention, the predistorter 400 is preferably designed so that the number of bits of the coefficients of respective terms of the predistortion work function become 20 bits, in order to more precisely adjust the level of the input signal.

When the nonlinear characteristic of the HPA 340 is mathematically modeled, the characteristic may be expressed by a polynomial including the first and second components (which are the components to the square of the level of a digital input signal), and also the predistortion work function for compensating the nonlinear characteristic may be expressed as a mathematical model having first and second components.

More specifically, a formula of the predistortion work function for determining the amount of the distortion of the respective digital input signals according to the level of the digital input signal is prepared as a quadratic polynomial, and a digital circuit for generating the quadratic polynomial is installed in the predistortion module 450 of the predistorter 400. Then, the actual level of the digital input signal is regarded as an input of the digital circuit for generating the quadratic polynomial, and the level of the digital input signals (I and Q signals) is distorted through by complex coupling unit 457.

In other words, the predistortion module 450 divides the digital input signal into two channels. A channel directly passes the original digital input signal, and the other channel generates the work function based on the power level of the digital input signal. Then, the two channel signals is complex-coupled so as to generate a distorted input signal which is inverse to the nonlinear characteristic of the HPA 340.

The operation of the above structured predistorter 400 will be described in detail hereinafter. Initially, the power measurement unit 451 obtains the square value by squaring the I-phase digital input signal in the first squarer 451a and obtains the square value by squaring the Q-phase digital input signal in the first squarer 451b. Then the first adder 451c sums the two square values and outputs the summed values. If the value obtained by adding the two square values (i.e., the output value (I²+Q²) of the adder 45c) is supposed as X, the work function generation unit 453 generates the predistortion work function using the level of the digital input signal which is outputted from the power measurement unit 451, i.e., the coefficients of respective terms of the predistortion work function outputted from the DSP 390.

The second adder 456a of the predistortion work function generation unit 453 generates the predistortion work function of the I signal as Formula 1, and the third adder 456b generates the predistortion work function of the Q signal as Formula 2.

In Formula 1, a_{I} designates a coefficient of a quadratic term of the predistortion work function corresponding to the I signal, b₁ designates a coefficient of a linear term of the predistortion work function corresponding to the I signal, and c_{I} designates a constant term of the predistortion work function corresponding to the I signal.

In Formula 2, a_{Q} designates a coefficient of a quadratic term of the predistortion work function corresponding to the Q signal, b_{Q} designates a coefficient of a linear term of the predistortion work function corresponding to the Q signal, and c_{Q} designates a constant term of the predistortion work function corresponding to the Q signal.

a_{I}X²+b_{I}X+c_{I}=I′ (1)

a_{Q}X²+b_{Q}X+c_{Q}=Q′ (2)

The complex coupling unit 457 distorts the original I and Q signals by complex-coupling the predistortion work functions corresponding to the respective I and Q signals from the work function generation unit 453 with the original I and Q signals ((I′+jQ′)×(I+jQ)). That is, a third multiplier 458a multiplies the I signal with the predistortion work function corresponding to the I signal, a fourth multiplier 458b multiplies the predistortion work function corresponding to the I signal with the Q signal, a fifth multiplier 458c multiplies the Q signal with the predistortion work function corresponding to the Q signal, and a sixth multiplier 458d multiplies the I signal with the predistortion work function corresponding to the Q signal.

The subtractor 459a distorts the I signal by subtracting the output of the third multiplier 458a from the output of the fifth multiplier 458c so as to have a characteristic which is inverse to the nonlinear characteristic of the HPA 340. The fourth adder 459b distorts the Q signal by adding the output of the fourth multiplier 458b to the output of the sixth multiplier 458d, so as to have a characteristic which is inverse to the nonlinear characteristic of the HPA 340.

The distorted I′ and Q′ signals are input into the digital IF processing unit 500. The I′ and Q′ signals are interpolated so that the data rate becomes two times higher than before interpolation by the first and second interpolators 511a, 511b, 512a, and 512b of the QPSK modulation module 510. The respective interpolated signals are modulated by QPSK modulation method, by multiplying the signals (cos) and (sin) that respectively 90° advanced and delayed in the modulator 513. The modulated signal is coupled with the intermediate frequency (IF) by the fifth adder 513c of the QPSK modulation module 510 and sent to an up-mixer 320.

The IF signal from the QPSK modulation module 510 is converted into an analog signal by the D/A converter 320 and the analog signal is outputted to the up-mixer 330. The analog signal output to the up-mixer 330 is mixed with the oscillation frequency in the local oscillator 380 so as to be the high frequency signal and the resulting signal amplified by the HPA 340. The amplified signal has a linear characteristic without the nonlinear characteristic.

Through the above process, a signal having a linear characteristic is output from the HPA 340. In so doing, the directional coupler 350 extracts the output of the HPA 340 and sends the output signal to a down-nixer 360. The down-mixer 360 converts the IF signal by mixing the output signal of the HPA 340 with the oscillation frequency from the local oscillator 380, and the IF signal is sent to the A/D converter 370. The A/D converter 370 converts the analog IF signal from the down-mixer into a digital signal and the digital signal is sent to the QPSK modulation module 520 of the digital IF processing unit 500. The QPSK modulation module 520 modulates the digital output signal from the A/D converter 370 so as to restore to a baseband signal, and the baseband signal is sent to the DSP 390.

In the demodulation process of the QPSK modulation module 520, the output signal from the A/D converter 370 is divided into two channels by the demodulator 521 of the QPSK modulation module 520. A channel signal is multiplied by the 90° advanced signal (cos) by the eleventh multiplier 521a of the demodulator 521 and demodulated into the I-phase signal. A signal of the other channel is multiplied with the 90° delayed signal (sin) by the twelfth multiplier 521b of the demodulator 521 and demodulated into the Q-phase signal. The demodulated signal of the I-phase is decimated so as to decrease as much as ½ in data rate at the decimator 522a. Then, the image signal in the decimated signal is removed by image removing filter 523a and the demodulated signal is restored to a baseband signal. Also, the demodulated Q-phase signal is decimated as much as ½ in data rage by the decimator 522B. Then, the image signals included in the signal is removed by the image removing filter 523B and the demodulated signal is restored to a baseband signal. In case the positions of the decimators 522a(522b) and image removing filter 523a(523b) are changed, the signal of the I(Q) phase from the demodulator 521 is decimated after the image signal is removed.

The baseband signal which is finally restored in the QPSK modulation module 520 is input into the DSP 390. The DSP 390 finds an optimal work function for adaptively operating the predistorter 400 of the preprocessing unit 310 and inputs the function to the predistorter 400, by comparing the I and Q digital input signals and the final output signal which is restored in the preprocessing unit 310. The DSP 390 therefore improves the nonlinear characteristic of the HPA 390 by adaptively operating the predistorter 400 by updating the coefficients of respective terms of the predistortion work functions corresponding to the I and Q-phases input signals.

As described above, in the linearized power amplification system of the present invention, since a signal is modulated in the digital domain using the digital QPSK modulator before the signal is converted into the analog signal, it is possible to prevent errors caused by an imbalance in the I and Q channels which occur in an analog domain modulation. Furthermore, non-linearized characteristics of the modulator itself are prevented from being generated, resulting in enhancement of the linearization characteristic of the HPA.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A linearized power amplification system, comprising:
a preprocessing unit for processing I- and Q-phase digital input signals in a digital domain;
a D/A converter for converting I′ and Q′ signals output from the preprocessing unit into an analog signal;
an up-mixer for up-converting the analog signal by multiplying the analog signal with a local oscillation frequency;
a high power amplifier (HPA) for amplifying and transmitting a high frequency signal output from the up-mixer into the air;
a feedback circuit which extracts an output signal from the HPA and converts the output signal into a digital signal for input into the preprocessing unit; and
a digital signal processor (DSP) which generates a coefficient for controlling the preprocessing unit using the I- and Q-phase digital input signals and the output signal of the HPA, which is processed in the digital domain by the preprocessing unit.

2. The system of claim 1, wherein the preprocessing unit includes:
a predistorter which distorts the I- and Q-phase digital input signals so as to have a characteristic which is inverse to the nonlinearized characteristic of the output signal of the HPA, using the coefficient from the DSP; and
a digital IF processing unit for modulating the I′ and Q′ signals pre-distorted by the predistorter and sending the modulated signals to the D/A converter, and demodulating the signal form the feedback circuit and inputting the demodulated signal to the DSP.

3. The system of claim 2, wherein the predistorter includes:
a gain control module which adjusts a level of the digital input signals based on a gain control signal from the DSP; and
a predistortion module which distorts the digital input signal adjusted in the gain control module so as to have a characteristic which is inverse to the nonlinear distortion characteristic of the HPA.

4. The system of claim 3, wherein the predistortion module includes:
a power measurement unit which measures a power level of the signal from the gain control module;
a predistortion work function generation unit which generates a predistortion work function based on the power level of the signal and a coefficient from the DSP; and
a complex coupling unit which pre-distorts the input signal by performing complex coupling of the predistortion work function generated in the predistortion work function generation unit and the digital input signal.

5. The system of claim 2, wherein the digital IF processing unit includes:
a modulation module which modulates the I′ and Q′ signals; and
a demodulation module which demodulates the signal from the feedback circuit.

6. The system of claim 5, wherein the modulation module includes:
a pair of first interpolators which increase data rates of the I′ and Q′ signals by interpolating the respective I′ and Q′ signals;
a pair of second interpolators which increase the data rate of the signal interpolated in the first interpolator again; and
a modulator which modulates the signal from the second interpolator.

7. The system of claim 6, wherein the modulator includes:
a pair of multipliers which respectively multiply 90°-advanced and 90°-delayed signals relative to the interpolated signal from the second interpolator; and
an adder which generates an IF signal by summing the signals outputted from the multipliers.

8. The system of claim 5, wherein the demodulation module includes:
a demodulator which separates the feedback signal into two channels signal by demodulating the signal;
a pair of decimators which decrease the data rate of respective signals to ½ by decimating the two demodulated signals; and
a pair of image filters which remove an image signal included in the decimated signals.

9. The system of claim 8, wherein the demodulator includes a pair of multipliers which multiply two separate channel signals with respective 90°-advanced (cos) and 90°-delayed (sin) signals.

10. The system of claim 1, wherein the feedback circuit includes:
a directional coupler which extracts the output signal of the HPA;
a down-mixer which down-converts the signal extracted in the directional coupler;
an A/D converter which converts the signal from the down-mixer into a digital signal and sends the converted analog signal to the preprocessing unit; and
a terminator which terminates the end of the transmission line so that the output signal of the HPA extracted by the directional coupler is not reflected.

11. A linearized power amplification system, comprising:
a predistorter for distorting the I- and Q-phase digital input signals so as to have a characteristic which is inverse to the nonlinearized characteristic of the output signal of the HPA, using the coefficient from the DSP;
a digital IF processing unit for modulating the I′ and Q′ signals pre-distorted by the predistorter, for sending the modulated signals to the D/A converter, and for demodulating the signal from the feedback circuit and inputting the demodulated signal to the DSP;
a D/A converter for converting I′ and Q′ signals output from the preprocessing unit into analog signals;
an up-mixer for up-converting the analog signals by multiplying the analog signal with the local oscillation frequency;
a high power amplifier (HPA) for amplifying and transmitting a high frequency signal output from the up-mixer into the air;
a feedback circuit for extracting an output signal from the HPA and converting the output signal into a digital signal so as to provide the digital signal to the preprocessing unit; and
a digital signal processor (DSP) for generating a coefficient for controlling the preprocessing unit using the I- and Q-phase digital input signals and the output signal of the HPA, which is processed in the digital domain by the preprocessing unit.

12. The system of claim 11, wherein the predistorter includes:
a gain control module for adjusting level of the digital input signals according to a gain control signal from the DSP; and
a predistortion module for distorting the digital input signal adjusted in the gain control module so as to have a characteristic which is inverse to the nonlinear distortion characteristic of the HPA.

13. The system of claim 12, wherein the predistortion module includes:
a power measurement unit for measuring power level of the signal from the gain control module;
a predistortion work function generation unit for generating a predistortion work function based on the power level of the signal and a coefficient from the DSP; and
a complex coupling unit for predistorting the input signal by performing complex coupling of the predistortion work function generated in the predistortion work function generation unit and the digital input signal.

14. The system of claim 11, wherein the digital IF processing unit includes:
a modulation module for modulating the I′ and Q′ signals; and
a demodulation module for demodulating the signal from the feedback circuit.

15. The system of claim 14, wherein the modulation module includes:
a pair of first interpolators for increasing data rates of the I′ and Q′ signals by interpolating the respective I′ and Q′ signals;
a pair of second interpolators for increasing the data rate of the signal interpolated in the first interpolator again; and
a modulator for modulating the signal from the second interpolator.

16. The system of claim 15, wherein the modulator includes:
a pair of multipliers for multiplying respectively 90°-advanced and 90°-delayed signals relative to the interpolated signal from the second interpolator; and
an adder for generating an IF signal by summing the signals outputted from the multipliers.

17. The system of claim 5, wherein the demodulation module includes:
a demodulator for separating the feedback signal into two channels signal by demodulating the signal;
a pair of decimators for decreasing the data rate of respective signals to ½ by decimating the two demodulated signals; and
a pair of image filters for removing an image signal included in the decimated signals.

18. The system of claim 17, wherein the demodulator is composed of a pair of multipliers for multiplying two separate channel signals with respective 90°-advanced (cos) and 90°-delayed (sin) signals.

19. The system of claim 11, wherein the feedback circuit includes:
a directional coupler for extracting the output signal of the HPA;
a down-mixer for down-converting the signal extracted in the directional coupler;
an A/D converter for converting the signal from the down-mixer into a digital signal and sending the converted analog signal to the preprocessing unit; and
a terminator for terminating the end of the transmission line so that the output signal of the HPA extracted by the directional coupler is not reflected.

20. A method for processing amplifier signals, comprising:
determining a nonlinear distortion characteristic of an amplifier;
digitally processing an input signal based on a transfer function which is inverse to said nonlinear distortion characteristic of the amplifier, said digital processing step including digitally modulating the input signal based on a predetermined intermediate frequency;
converting the digitally processed input signal into an analog signal; and
inputting the analog signal into the processor.

21. The method of claim 20, wherein said digital processing step includes:
digitally processing an input signal based on an intermediate frequency.

22. The method of claim 20, further comprising:
predistorting the input signal based on a gain-control signal determined during said digital processing step.

23. The method of claim 23, wherein said predistorting step includes:
measuring a power level of the input signal; and
distorting the input signal based on a predistortion work function based on the measured power level and coefficients derived from said digital processing step.

24. The method of claim 20, wherein said digital processing step includes:
adjusting a level of the input signal based on a feedback gain control signal.
